(19) United States
(12) Patent Application Publication
(10) Pub. No.: US 2014/0089212 A1
(43) Pub. Date: Mar. 27, 2014

(54) DATA SHARING AGREEMENTS

(71) Applicant: Marco Luca Sbodio, Torino (IT)

(72) Inventor: Marco Luca Sbodio, Torino (IT)

(21) Appl. No.: 14/116,167

(22) PCT Filed: May 20, 2011
(86) PCT No.: PCT/EP2011/058303

§ 371 Date: Nov. 7, 2013

(51) Int. Cl. G06Q 50/18; G06Q 10/10

(52) U.S. Cl. CPC G06Q 50/18; G06Q 10/10
USPC 705/311

(57) ABSTRACT

Presented is an electronic data sharing agreement authoring system and method for creating an electronic sharing agreement comprising at least one statement for defining data sharing between entities and conforming to a predefined syntax.

Organizations and/or individuals (hereafter generally referred to as entities) may use legal documents (such as contracts or agreements) to regulate the terms and conditions under which they agree to share data. A Data Sharing Agreement (DSA) is such an agreement among contracting parties regulating how they may share data.

DSAs are typically written using natural language, which, from a computational point of view, is complex, difficult to parse, and prone to ambiguity. To address such shortcomings, electronic-DSAs (e-DSAs) have been developed. An e-DSA is a machine-readable document regulating how data may be shared between organizations and/or individuals (i.e. entities).

An e-DSA a multilateral agreement typically comprises information including the definition of the validity period, the entities participating in the agreement, and statements defining how data may be shared among the participating entities. Such statements usually include authorizations and obligations.

Exemplary embodiments will now be described with reference to the accompanying diagrams, in which:

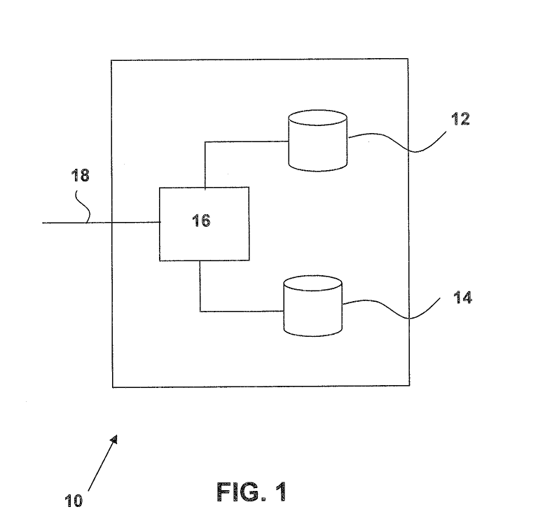

FIG. 1 is an illustration of an e-DSA authoring system according to a first embodiment;

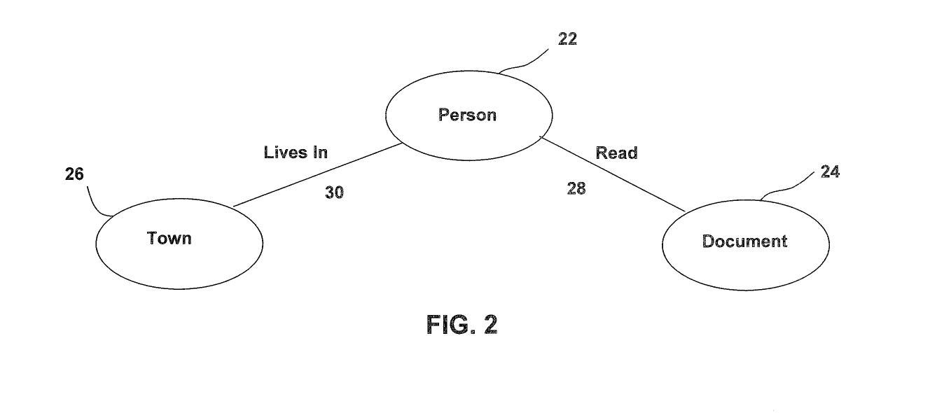

FIG. 2 illustrates a domain ontology representing a domain vocabulary according to an embodiment;

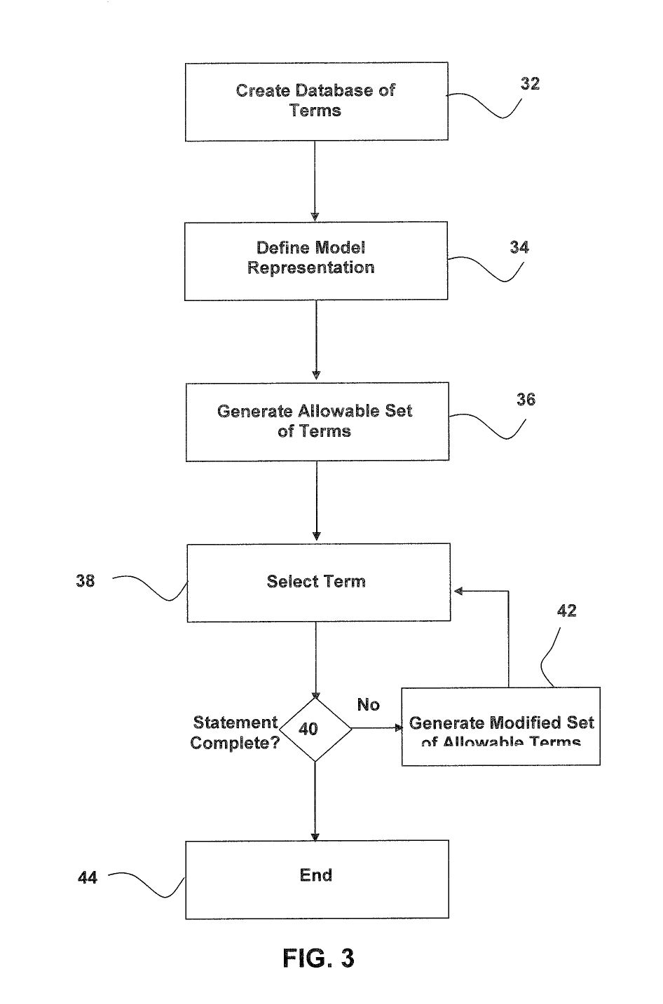

FIG. 3 is a flow diagram of a method for creating an e-DSA according to an embodiment;

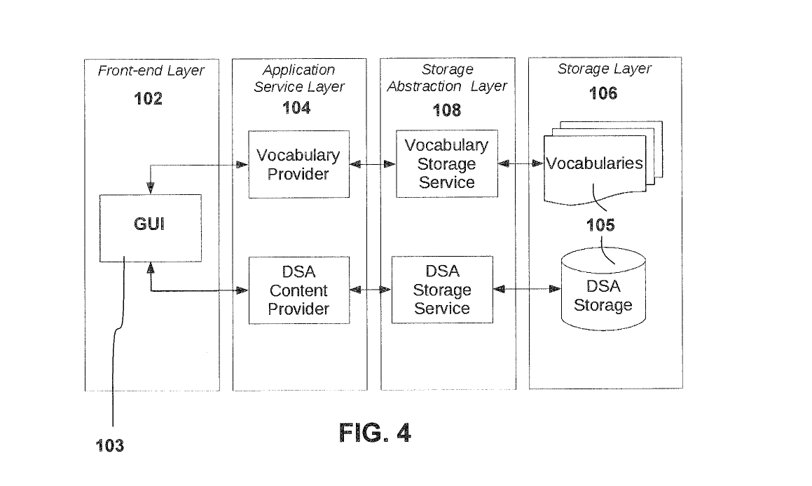

FIG. 4 illustrates the high-level architecture of an e-DSA editor according to an embodiment;

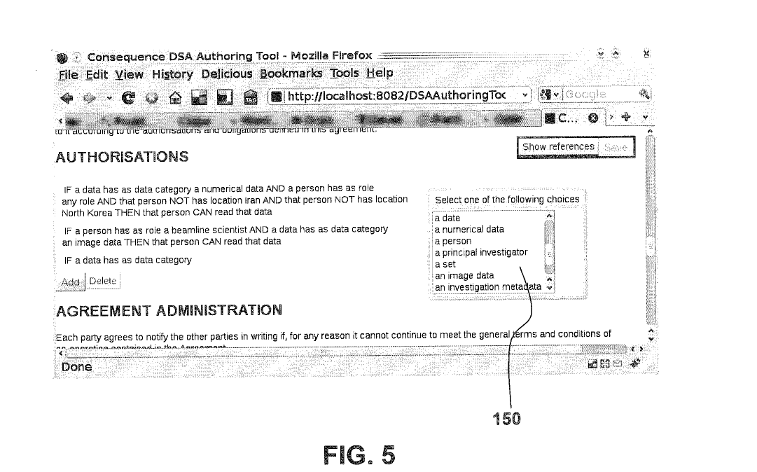

FIG. 5 is a screenshot of an e-DSA authoring software application according to an embodiment;

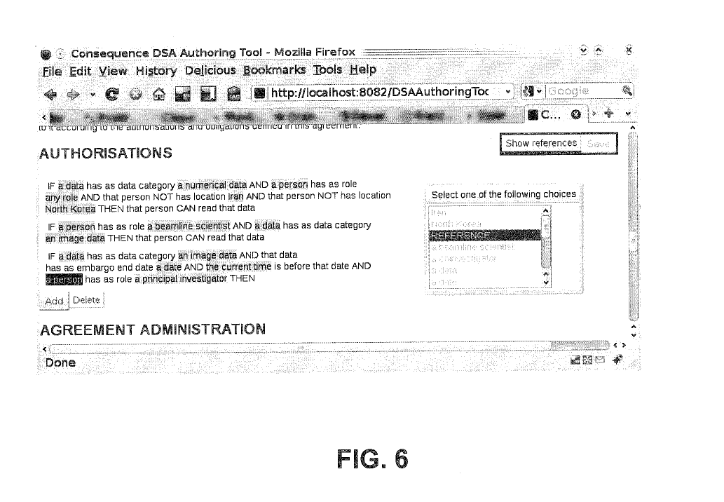

FIG. 6 is a screenshot of the e-DSA authoring software application shown if FIG. 5, wherein a user is inserting a reference in a statement; and

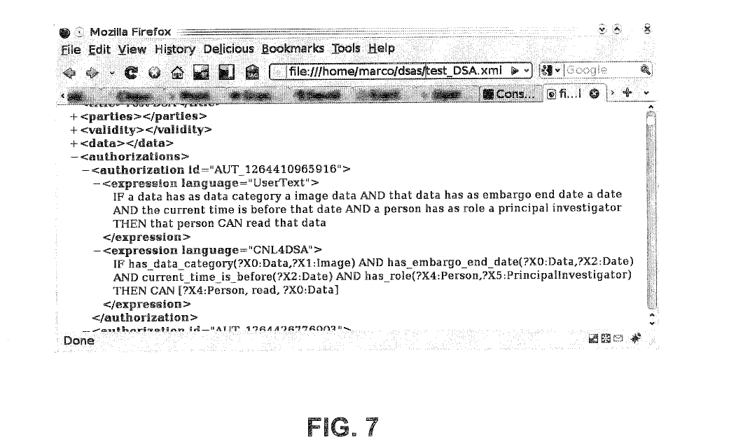

FIG. 7 shows an excerpt of an e-DSA created according to an embodiment, wherein the e-DSA is represented in an XML.

Currently, there are various policy specification languages, such as the W3C Recommendation P3P, the OASIS XACML standard, the LegalXML and other proposals such as EPAL. Such languages address different aspects of policies and legal documents specification by providing a formal syntax for e-DSAs that enable machine processing. In order to increase the human readability of a policy language, some researchers have proposed the adoption of controlled natural languages (CNL). There has been proposed a Controlled Natural Language for Data Sharing Agreements (CNL4DSA) which aims to provides simplicity for end users whilst also permitting translation to formal specifications enabling automated verification and enforcement of an e-DSA.

It is proposed to provide a system and method for creating an e-DSA conforming to a predefined formal syntax (such as that used by a CNL). Using such a system/method, non-technical users may easily create and/or edit an e-DSA that adheres to formal representation requirements for machine processing.

An exemplary method according to an embodiment comprises the steps of: providing a plurality of terms; representing one or more relationships between the plurality of terms using a model; selecting one of the plurality of terms; and, based on the selected term and the model, defining a set of allowable terms for selection which conform to a predefined syntax.

According to an embodiment, there is provided an electronic data sharing agreement authoring system 10 as illustrated in FIG. 1. The system 10 is adapted to generate e-DSAs comprising one or more statements for defining data sharing between entities and conforming to a predefined syntax.

The system 10 comprises first 12 and second 14 data stores, a processing unit 16 and an input/output (I/O) interface 18. The first data store 12 is adapted to store a database of terms that may be used to construct statements of an e-DSA. The second data store 14 is adapted to store a model representation of the relationships existing between the terms of the database (stored by the first data store 12).

The processor is adapted to access both the first 12 and second 14 data stores, in addition to receiving and transmitting signals via the I/O interface 18. Using the information stored in the first 12 and second 14 data stores, the processing unit 16 defines an allowable set of terms that accord to the predefined syntax. The allowable set of terms is provided to a user via the I/O interface 18.

The I/O interface 18 is adapted to receive a user input selecting a term from the allowable set of terms. The processing unit 18 is adapted to receive the user input and, based on the user input and model representation, the processing unit 16 generates a modified set of allowable terms and provides the modified set of allowable terms to the user via the I/O interface 18. By basing generation of the modified set of allowable terms on user selection and the stored model representation, the processing unit 16 is adapted to ensure that the modified set of allowable terms conforms to the predefined syntax. Thus, from the modified set of allowable terms, the user is only able to select a subsequent term that conforms to the predefined syntax.

By adapting the processor to generate modified allowable sets of terms based upon previous user inputs and the model representation, a user may be forced to only select certain combinations or sequences of terms that create statements (such as authorizations, prohibitions, obligations, etc.) adhering to syntax requirements.

Embodiments are therefore adapted to assist a user in writing syntactically-correct machine-readable statements for eDSAs. The correctness of a statement may also concern its semantics. Embodiments may ensure that syntax is correct by enforcing terms to be selected in accordance with syntax patterns defined in the grammar of the predefined language, such as the known CNL4DSA language. e-DSAs generated using an embodiment may be suitable for automated processing (including analysis and enforcement) of statements contained therein.

Embodiments may use a database of terms (in other words, a vocabulary) to provide users with terms for building statements. Such a vocabulary may be further defined using a model representing one or more relationships between to the terms of the vocabulary, wherein the model provides a formal (machine readable/processable) representation of a domain by defining relationships that exist between terms.

One such exemplary model may be ontology. An ontology is a formal representation (i.e. structural framework) of knowledge as a set of concepts or objects within a domain, and the relationships between those concepts/objects.

Ontologies share many structural similarities, regardless of the language in which they are expressed. Typically, most ontologies describe individuals (instances), classes (concepts), attributes, and relations. Common components of ontologies include the following:
Individuals: instances or objects (the basic or “ground level” objects)
Attributes: aspects, properties, features, characteristics, or parameters that objects (and classes) can have
Relations: ways in which classes and individuals can be related to one another
Function terms: complex structures formed from certain relations that can be used in place of an individual term in a statement
Restrictions: formally stated descriptions of what must be true in order for some assertion to be accepted as input
Rules: statements in the form of an if-then (antecedent-consequent) sentence that describe the logical inferences that can be drawn from an assertion in a particular form

A domain ontology (or domain-specific ontology) models a specific domain, or part of the world. It represents the particular meanings of terms as they apply to that domain.

An upper ontology (or foundation ontology) is a model of the common objects that are generally applicable across a wide range of domain ontologies.

Embodiments may employ a proposed upper ontology that defines the notions of “Term” and “Action”, and the generic relations “hasObject” (linking an “Action” with the set of its possible objects) and “hasSubject” (linking an “Action” with the set of its possible subjects). Here, a model representation may be an instance of such an upper ontology which defines a domain vocabulary in which several terms and actions are defined. In addition to “hasObject” and “hasSubject” for actions, a domain vocabulary can also provide a plurality of specialized relations linking terms. Such specialized relations can be used to represent language predicates that a user can exploit to build statements.

As an example, one may assume a domain vocabulary that defines the action “Read”, and the terms “Person”, “Document”, “Town”. A domain vocabulary according to an embodiment may define that Read-hasObject-Document (meaning that a Document is a possible object for the action Read), and Read-hasSubject-Person (meaning that a Person is a possible subject for the actions Read). Further, the domain vocabulary may define the predicate “lives in” whose domain is “Person” and whose range is “Town”.

An illustration of a domain ontology (instantiated according to a proposed upper ontology) representing such a domain vocabulary is provided in FIG. 2. It will be seen that the terms “Person” 22, “Document” 24 and “Town” 26 are instances or objects, and that the action “Read” 28 defines a relation between the “Person” 22 and “Document” 24 objects. Also, the predicate “lives in” 30 defines a relation between the “Person” 22 and “Town” 26 objects.

Given such semantics, a system according to an embodiment may be adapted to guide or restrict a user to create statements like “a person reads a document”, whilst preventing a user from creating a statement such as “a person reads a town”. Further, a system according to an embodiment may be also be adapted to guide or restrict a user to create statements like “if a person lives in a town . . . ”, whilst preventing a user from creating a statement such as “if a person lives in a document . . . ”.

For example, if a user input defines a user has selected the term “person” and action “read”, the processing unit 16 of the system 10 of FIG. 1 may be adapted to remove the term “town” from an allowable set of terms (based on the defined ontology shown in FIG. 2), thus ensuring that user cannot select the term “town” and create a statement that does not accord to the required syntax. Instead, the processing unit 16 may present an allowable set of terms comprising the term “document”, thus guiding or restricting the user to create a statement adhering to the required syntax and semantics.

From the above example it will be understood that a relationship between first and second terms may define whether or not the second term may be an allowable term for selection (i.e. conform to the predefined syntax) if the first term is selected. The relationship may be defined using a property or attribute that can be applied to the first and second terms.

A method for creating an e-DSA according to an embodiment will now be described with reference to FIG. 3. In block 32, a database comprising a plurality of terms is provided. Such a database may contain a list of terms used in a domain vocabulary.

In block 34, a model defining relationships between the terms of the database is created. As with the previous example described above, the model may employ an upper ontology (like that illustrated in FIG. 2) having terms as objects/instances and having relations between terms defined using actions and/or predicates.

Next, in block 36, an allowable set of terms adhering to a predefined syntax are defined using the database of terms and the model. From the allowable set of terms, a user selects a term in block 38.

Next, in block 40, it is determined whether or not a statement for an e-DSA has been defined using the term(s) selected so far. If it is determined that a statement has not been defined, the method continues to block 42. Based on the most recent user selected term and the model, a modified set of allowable terms conforming to the predefined syntax is generated in block 42. The method then returns to block 38.

If, in block 40, it is determined that a statement for an e-DSA has been defined using the selected term(s), the method proceeds to block 44 in which the statement is concluded for inclusion in an e-DSA and the method terminates.

It will be appreciated embodiments may make use of any vocabulary in conjunction with a model representing relationships between terms of the vocabulary. For example, embodiment may employ terms defined according to an upper ontology like that described above (with reference to FIG. 2), and thus be able to adapt to various domains (where each domain has its own set of specialized actions, terms, and related predicates).

Embodiments may be provided as a software program or application that is adapted to enable users to interactively create, edit or author an e-DSA. Such embodiments may use a Controlled Natural Language defining the syntax of statements defining data sharing between entities, and one or more customizable databases defining terms, actions and predicates that user can combine to build such statements.

FIG. 4 illustrates the high-level architecture of an e-DSA editor 100 according to an embodiment. The front-end layer 102 is a lightweight Web 2.0 application enabling interactive editing of an e-DSA via a graphical user interface 103. The front-end layer uses an application service layer 104 for accessing e-DSA data and a related vocabulary of terms stored in storage means 105 in a storage layer 106. A storage abstraction layer 108 decouples the application service layer 104 from the actual storage systems (file-system, database or content management systems, etc.) used for storing e-DSAs and vocabularies in the storage layer 106.

The e-DSA Editor 100 is adapted to display predefined legal background information from an available e-DSA template, and allows the user to interactively fill in or create statements of the e-DSA. The e-DSA Editor guides the user in creating such statements by using the customizable vocabulary of allowable terms, and by ensuring that user can only select combinations or sequences of terms that form statements adhering to a predefined formal syntax for e-DSAs (such as that provided by the W3C Recommendation P3P, the OASIS XACML standard, the LegalXML proposal, EPAL or CNL4DSA), and to the semantics defined in the domain ontology.

The following authorization statement is an example of a statement that a user can create with the e-DSA Editor 100:

“IF a data has as data category a numerical data AND that data has as embargo end date a date AND the current time is before that date AND a person has as role a principal investigator THEN that person CAN read that data”

The e-DSA Editor 100 guides the editing or authoring of statements by displaying a set of allowable terms taken from a customizable vocabulary, wherein the set of allowable terms takes account of relationships between terms and predefined syntax patterns. For example, where the predefined syntax restricts a statement to having the following structure: “IF [set of conditions] THEN [subject] CAN [action] [object]”), a user selection of the chosen “set of conditions” will cause the e-DSA editor 100 to analyse the selection in conjunction with defined relationships between terms and the required syntax of the statement and to display a further set of allowable “subject” terms for selection. This ensures that the user cannot select an “action” to create a statement that does not accord to the statement structure required syntax.

Such syntax patterns or structures are defined in the known formal e-DSA language called CNL4DSA. CNL4DSA defines the structure of permitted statements, yet remains open with respect to the actual terms used to build the statements. Thus, term can be taken from a definable (and variable) database of terms (i.e. a vocabulary). By defining relationships between terms of the database using a formal model (such as an ontology or a hierarchical tree), embodiment can be adapted to ensure syntactical correctness of the statements.

FIG. 5 shows a screenshot of an e-DSA authoring software application according to an embodiment, wherein a user is editing a statement for an e-DSA. A list 150 of the allowable terms for use in creating a statement for an e-DSA is displayed in a pop-up window at the right-hand side of the application window.

When authoring a statement, the user may also make references to previously used terms (in the same or other statements). For example, in the first statement shown in the screenshot of FIG. 5, the expression “that data” at the end of the statement is a reference to the term “data” appearing earlier in the statement (“IF a data . . . ”).

The e-DSA authoring software application enables the creation of statements for an e-DSA using a simple point-and-click interface. In other words, a user select a desired term from an allowable set of terms by simply pointing and clicking on the desired term, and the application automatically inserts the term into the statement whilst generating the necessary references and/or code.

Further, the application can be adapted to highlight references in the various statements, thus showing the implicit interconnections.

FIG. 6 shows a screenshot of the authoring software application of FIG. 5, wherein a user is inserting a reference in the third (bottom) statement.

In addition to providing user-friendly e-DSA authoring capabilities, the e-DSA authoring software application is adapted to make sure that dynamically created authorization and/or obligations statements are formally encoded according to a predefined e-DSA language (such as CNL4DSA, for example), thus enabling automated processing of statements. Thus, the e-DSA authoring software application of this example is adapted to generate e-DSAs which adhere to a predefined legal template and comprise dynamically created statements that define how entities (participating in the agreement) may share data.

Such a generated e-DSA may be represented and saved in an eXtensible Markup Language (XML) and contains both the human-readable and machine-readable versions of authorizations and/or obligation statements. FIG. 7 shows an excerpt of an e-DSA created according to an embodiment and represented in an XML. Here, it will be seen that an authorization statement is represented in both human-readable text and in a CNL4DSA format.

An XML version of an e-DSA may enable automated analysis of the e-DSA. In other words, the e-DSA statements may be extracted and provided to model verification tools. Such tools can perform a set of automated and/or interactive analysis to identify problems or inconsistencies in the e-DSA statements. An XML version of an e-DSA may also allow for automated translation of the e-DSA into enforceable (security) policies which comprise rules that may deployed in an IT-infrastructure and enacted at run-time (thus ensuring that obligations/authorizations/prohibitions defined in the e-DSA are actually enforced).

While specific embodiments have been described herein for purposes of illustration, various modifications will be apparent to a person skilled in the art and may be made.

1. An electronic data sharing agreement authoring method for creating an electronic sharing agreement comprising at least one statement for defining data sharing between entities and conforming to a predefined syntax; the method comprising:
providing a database comprising a plurality of terms;
providing a model defining one or more relationships between the plurality of terms;
receiving a user input for selecting a term from an allowable set of the plurality of terms that conform to the predefined syntax; and
based on the user input and the model, defining a modified set of allowable terms for selection by the user and conforming to the predefined syntax.

2. The method of claim 1, wherein the model comprises an ontology representing relationships between a plurality of objects, and wherein each object of the ontology is adapted correspond to one of the plurality of terms.

3. The method of claim 1, wherein a relationship between first and second terms defines whether or not the second term may be an allowable term for selection conforming to the predefined syntax if the first term is selected.

4. The method of claim 1, wherein a relationship between first and second terms is defined using a property of the first and second terms.

5. The method of claim 1 wherein the predefined syntax is defined in accordance with a controlled natural language for data sharing agreements.

6. The method of claim 1 wherein the at least one statement is represented using an extensible markup language.

7. An electronic data sharing agreement authoring system for creating an electronic sharing agreement comprising at least one statement for defining data sharing between entities and conforming to a predefined syntax; the system comprising:
data storage means adapted to share a plurality of terms;
model storage means adapted to store a model defining one or more relationships between the plurality of terms;
a user interface adapted to receive a user input for selecting a term from an allowable set of the plurality of terms that conform to the predefined syntax; and
a processor adapted to define a modified set of allowable terms for selection by the user and conforming to the predefined syntax, based on the user input and the model.

8. The system of claim 7, wherein the model comprises an ontology representing relationships between a plurality of objects, and wherein each object of the ontology is adapted correspond to one of the plurality of terms.

9. The system of claim 7, wherein a relationship between first and second terms defines whether or not the second term may be an allowable term for selection conforming to the predefined syntax if the first term is selected.

10. The system of claim 7, wherein a relationship between first and second terms is defined using a property of the first and second terms.

11. The system of claim 7, wherein the predefined syntax is defined in accordance with a controlled natural language for data sharing agreements.

12. The system of claim 7, wherein the at least one statement is represented using an extensible markup language.

13. A computer program comprising computer program code means adapted to perform, when on a computer, the steps of:
providing a database comprising a plurality of terms for creating a machine readable statement defining data sharing between entities;
providing a model defining one or more relationships between the plurality of terms;
receiving a user input for selecting a term from an allowable set of terms that conform to a predefined syntax; and
based on the user input and the model, defining a modified set of allowable terms for selection by the user and conforming to the predefined syntax.

14. A computer program as claimed in claim 13 embodied on a computer readable medium.

15. (canceled)
